(19) United States
(12) Patent Application Publication
(10) Pub. No.: US 2016/0093055 A1
(43) Pub. Date: Mar. 31, 2016

(54) INFORMATION PROCESSING APPARATUS, METHOD FOR CONTROLLING SAME, AND STORAGE MEDIUM

(71) Applicant: CANON KABUSHIKI KAISHA, Tokyo (JP)

(72) Inventor: Hiroyuki Sato, Tokyo (JP)

(21) Appl. No.: 14/863,179

(22) Filed: Sep. 23, 2015

(30) Foreign Application Priority Data
Sep. 29, 2014 (JP) 2014-199182

(51) Int. Cl. G06T 7/00; G06F 3/01; G06K 9/20; G06T 7/60; G06K 9/00

(52) U.S. Cl. CPC G06T 7/0044; G06T 7/602; G06K 9/00355; G06K 9/2054; G06F 3/017; G06T 2207/30196

(57) ABSTRACT

An apparatus includes an extraction unit configured to extract an area showing an arm of a user from a captured image of a space into which the user inserts the arm, a reference point determination unit configured to determine a reference point within a portion corresponding to a hand of the user in the area, a feature amount acquisition unit configured to obtain a feature amount of the hand corresponding to an angle around the reference point, and an identification unit configured to identify a shape of the hand in the image by using a result of comparison between the feature amount obtained by the feature amount acquisition unit and a feature amount obtained from dictionary data indicating a state of the hand. The feature amount is obtained from the dictionary data corresponding to an angle around a predetermined reference point.

### BACKGROUND OF THE INVENTION

1. Field of the Invention

The present invention relates to a technique for identifying a posture of a user's hand.

2. Description of the Related Art

A user interface (UI) capable of receiving gesture inputs can identify hand postures of a user. In this manner, various gesture commands issued by combinations of the postures and movement loci can be recognized by the user interface. The postures generally refer to distinctive states of the hand, where only a predetermined number of fingers are extended or where all the fingers and the thumb are clenched, for example. Japanese Patent Application Laid-Open No. 2012-59271 discusses a technique for identifying a posture of a hand from a captured image. According to Japanese Patent Application Laid-Open No. 2012-59271, an area (arm area) showing an arm is extracted from the captured image by elliptical approximation. Areas that lie in the major-axis direction of the ellipse and far from the body are identified as fingertips, and the posture of the hand is identified from a geometrical positional relationship of the fingertips.

A technique called machine vision (MV) may include identifying an orientation of an object having a specific shape such as machine parts based on matching between an image obtained by capturing the object using a red, green, and blue (RGB) camera or a range image sensor, and dictionary data. Japanese Patent Application Laid-Open No. 10-63318 discusses a technique for extracting a contour of an object from an image, and rotating dictionary data to identify a rotation angle at which a degree of similarity between a feature amount of an input image and that of the dictionary data is high, while treating a distance from a center of gravity of the object to the contour as the feature amount.

One advantage of gesture inputs is a high degree of freedom in the position and direction of input as compared to inputs that need to make contact with a physical button or touch panel. However, to enable gesture inputs in arbitrary directions and to identify fingertips from a captured image and identify the posture of the hand based on the positional relationship as discussed in Japanese Patent Application Laid-Open No. 2012-59271, an enormous amount of dictionary data previously storing the positional relationship of the fingertips seen in all directions is needed. Moreover, an arm area extracted from a captured image of a person often includes portions irrelevant to the identification of the posture and is off-centered in shape. When the dictionary data is rotated as shown in Japanese Patent Application Laid-Open No. 10-63318 to perform matching while the user's hand moves at some rotation angle, an appropriate center around which to rotate the dictionary data needs to be determined.

### SUMMARY OF THE INVENTION

According to an aspect of the present invention, an apparatus includes an extraction unit configured to extract an area showing an arm of a user from a captured image of a space into which the user inserts the arm, a reference point determination unit configured to determine a reference point within a portion corresponding to a hand in the area extracted by the extraction unit, a feature amount acquisition unit configured to obtain a feature amount of the hand corresponding to an angle around the reference point determined by the reference point determination unit, and an identification unit configured to identify a shape of the hand of the user in the image by using a result of comparison between the feature amount obtained by the feature amount acquisition unit and a feature amount obtained from dictionary data indicating a state of the hand of the user, the feature amount obtained from the dictionary data corresponding to an angle around a predetermined reference point.

Further features of the present invention will become apparent from the following description of exemplary embodiments with reference to the attached drawings.

### BRIEF DESCRIPTION OF THE DRAWINGS

FIG. 1 is a diagram illustrating an example of an appearance of a tabletop system using an information processing apparatus.

FIGS. 2A and 2B are block diagrams illustrating a hardware configuration and a functional configuration of the information processing apparatus, respectively.

FIGS. 3A, 3B, 3C, 3D, 3E, and 3F are diagrams illustrating an outline of processing for identifying a shape of an object using a contour of the object and a position of a reference point.

FIG. 4 is a table illustrating an example of feature amounts stored as dictionary data.

FIGS. 5A and 5B are diagrams illustrating a plurality of examples of a reference point in an arm area used for matching.

FIGS. 6A and 6B are diagrams illustrating examples of an input image when a hand or hands take(s) a “pointing posture.”

FIG. 7 is a diagram illustrating examples of the contour of a hand area when a hand takes the “pointing posture.”

FIGS. 8A and 8B are diagrams illustrating examples of arm areas with different postures and entry directions, respectively.

FIGS. 9A and 9B are flowcharts illustrating an example of a flow of reference point identification processing and feature amount acquisition processing, respectively.

FIGS. 10A and 10B are flowcharts illustrating an example of a flow of dictionary generation processing and hand posture identification processing, respectively.

FIG. 11 is a flowchart illustrating an example of a flow of processing for identifying a shape of a hand area.

FIGS. 12A and 12B are diagrams illustrating use examples of the hand posture identification processing by an application.

FIG. 13 is a diagram illustrating a use example of the hand posture identification processing by an application.

### DESCRIPTION OF THE EMBODIMENTS

An exemplary embodiment of the present invention will be described in detail below with reference to the drawings. The following exemplary embodiment describes just an example of a case where the present invention is concretely implemented. The present invention is not limited thereto.

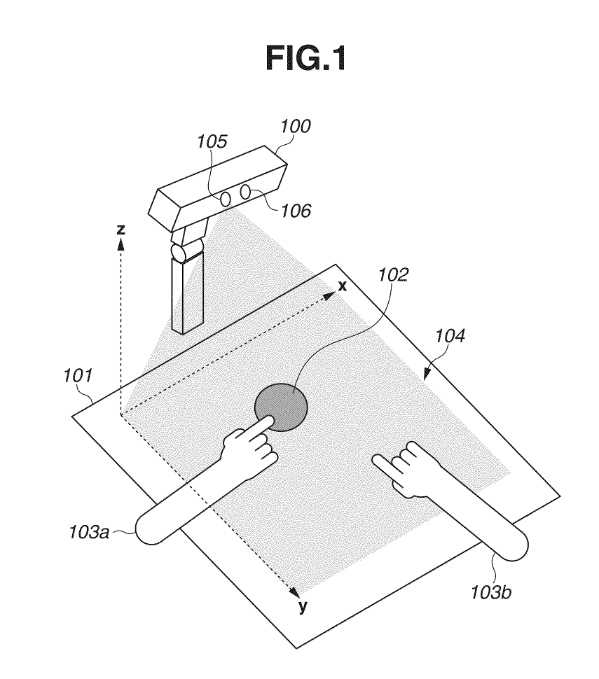

FIG. 1 illustrates an example of an appearance of a tabletop system in which an information processing apparatus 100 described in the present exemplary embodiment is installed. The information processing apparatus 100 can irradiate an arbitrary plane such as a table top and a wall surface with projection light from a projection light irradiation unit 105 of a projector, thereby setting the arbitrary plane as an operation surface 104. In the case of the tabletop system illustrated in FIG. 1, the information processing apparatus 100 is arranged on a table surface 101 so that a display image is projected on the table surface 101. A circular image 102 is a UI component projected on the table surface 101 by the projector. Hereinafter, various images including UI components and pictures projected on the table surface 101 by the projector will all be referred to collectively as “display items” or “UI components”.

A light receiving unit 106 represents a point of view of a range image obtained by an infrared pattern projection range image sensor 115. In the present exemplary embodiment, the light receiving unit 106 is arranged in a position where an image is captured at a downward viewing angle towards the operation surface 104. Therefore, a distance from the light receiving unit 106 to an object is thus reflected in each pixel of the range image obtained by the range image sensor 115. As an example, a method for obtaining the range image will be described based on the infrared pattern projection system which is less susceptible to ambient light and the display on the table surface 101. A parallax system or an infrared reflection time system may also be used depending on the intended use. An area of the operation surface 104 on which the projector can make a projection coincides with the range of view of the range image sensor 115. Such a range will hereinafter be referred to as an operation area 104. The light receiving unit 106 does not necessarily need to be arranged above the operation surface 104 as long as the light receiving unit 106 is able to obtain an image of the operation surface 104. For example, the light receiving unit 106 may be configured to receive reflection light by using a mirror.

In the present exemplary embodiment, the user can insert his/her arms into a space between the operation surface 104 and the light receiving unit 106 of the range image sensor 115 in a plurality of directions, for example, as indicated by an arm 103a and an arm 103b. The user inputs a gesture operation to the tabletop system using the hand to operate the display items as operation objects. The present exemplary embodiment is applicable not only when the display items are projected on the table surface 101, but also when the display items are projected, for example, on a wall surface or when the projection surface is not a flat surface. In the present exemplary embodiment, as illustrated in FIG. 1, an x-axis and a y-axis are set on a two-dimensional plane parallel to the operation surface 104, and a z-axis in a height direction orthogonal to the operation surface 104. Three-dimensional position information is handled as coordinate values. The coordinate axes do not necessarily need to have a parallel or orthogonal relationship to the operation surface 104 if the operation surface 104 is not a flat plane, or depending on a positional relationship between the user and the operation surface 104. Even in such cases, the z-axis is set in a direction where a proximity relationship between the object to be recognized and the operation surface 104 (a degree of magnitude of the distance therebetween) is detected. The x- and y-axes are set in directions intersecting the z-axis.

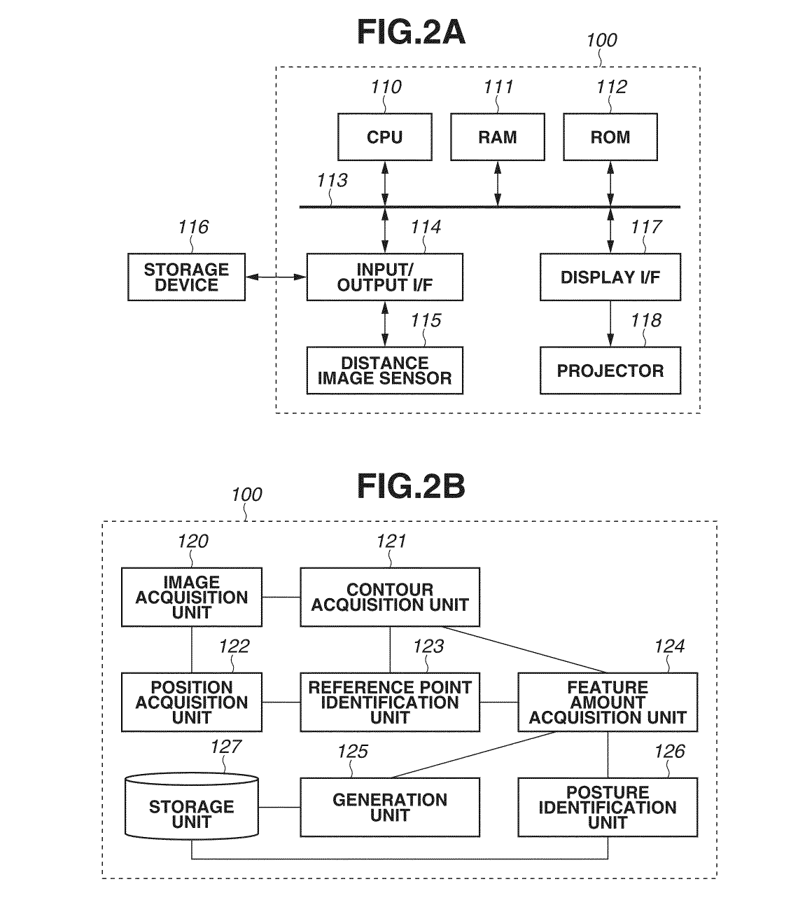

FIG. 2A is a block diagram illustrating an example of a hardware configuration of the information processing apparatus 100 according to the present exemplary embodiment. In FIG. 2A, a central processing unit (CPU) 110 controls devices connected via a bus 113 in a centralized manner. Processing programs and device drivers according to an exemplary embodiment of the present invention as illustrated in flowcharts described below, including an operating system (OS), are stored in a read-only memory (ROM) 112. The processing programs and device drivers are temporarily stored in a random access memory (RAM) 111 and executed by the CPU 110 when needed. The RAM 111 is used as a temporary storage area capable of performing high-speed access, such as a main memory and a work area of the CPU 110. The OS and the processing programs may be stored in an external storage device 116. In such a case, necessary information is read into the RAM 111 as needed upon power-on. A display interface (I/F) 117 converts a display item (display image) generated inside the information processing apparatus 100 into a signal processable by a projector 118. The range image sensor 115 captures a range image in which range information on distances between the sensor and surface of subjects included in the angle of field is reflected. For example, in a case of a Time-of-flight method, the range information may be obtained, based on the known speed of light, by measuring a Time-of-Flight of a light signal between the sensor and the subject for each pixel of the image. And in a case of an infrared pattern projection method, the range information may be obtained by irradiating a specially designed infrared-light pattern on the subject and comparing between the irradiated pattern with a captured image of the reflected light. In the present example, the infrared pattern projection method which is less affected by ambient light and display of a table surface is employed. An input/output I/F 114 obtains distance information from the range image sensor 115 and converts the distance information into information processable by the information processing apparatus 100. The input/output I/F 114 also performs mutual data conversion between the storage device 116 and the information processing apparatus 100.

In the present exemplary embodiment, digital data to be projected by the information processing apparatus 100 is stored in the storage device 116. Examples of the storage device 116 include a disk device, a flash memory, and a storage device connected via a network or various types of input/output I/Fs 114 such as Universal Serial Bus (USB). In the present exemplary embodiment, the range image sensor 115 is an imaging unit used to obtain information on the operation area 104. An image obtained by the range image sensor 115 is temporarily stored in the RAM 111 as an input image, and processed and discarded by the CPU 110 as appropriate. Necessary data may be accumulated in the storage device 116 as needed.

FIG. 2B is a block diagram illustrating an example of a functional configuration of the information processing apparatus 100 according to the present exemplary embodiment. The information processing apparatus 100 includes an image acquisition unit 120, a contour acquisition unit 121, a position acquisition unit 122, a reference point identification unit 123, a feature amount acquisition unit 124, a generation unit 125, and a posture identification unit 126. Such functional units are implemented by the CPU 110 loading the programs stored in the ROM 112 into the RAM 111 and performing processing according to the flowcharts to be described below. As an alternative to the software processing using the CPU 110, for example, the information processing apparatus 100 may be configured with hardware devices. In such a case, arithmetic units and circuits corresponding to the processing of the respective functional units to be described below may be configured. A storage unit 127 is a functional unit corresponding to either one of the ROM 112 and the storage device 116. The storage unit 127 stores dictionary data generated by the generation unit 125 and image data based on which an image is output to the projector 118.

The image acquisition unit 120 obtains information indicating a range image captured by the range image sensor 115 as information about an input image at regular time intervals. The image acquisition unit 120 stores the obtained information in the RAM 111 as needed. The position of each pixel of the range image described by the obtained information is expressed in (x,y) coordinates illustrated in FIG. 1. The pixel value of each pixel corresponds to the coordinate value in the z direction. While it is actually a signal corresponding to image data that the image acquisition unit 120 obtains and exchanges with various functional units, the image acquisition unit 120 is hereinafter simply described as functioning to “obtain a range image.” The contour acquisition unit 121 extracts an area (arm area) showing a human arm from the range image obtained by the image acquisition unit 120. The contour acquisition unit 121 obtains position information indicating the contour, and stores the information in the RAM 111. As employed herein, a human arm refers to an entire portion from a person's shoulder to fingertips. An arm area of a captured image refers to an area that shows part of the portion corresponding to a human arm. In the present exemplary embodiment, the hand refers to an entire portion from the wrist to a tip part of the arm. The hand includes four fingers, a thumb, a palm, and a back of the hand. In actual processing, the contour acquisition unit 121 performs threshold processing on the coordinate values in the z direction indicated by the respective pixels of the obtained range image. The contour acquisition unit 121 thereby extracts an area that has coordinate values higher than the table and is in contact with an image edge, as an arm area. However, the method for extracting an arm area is not limited thereto. For example, a portion corresponding to a skin color area in an RGB image of the separately captured operation area 104 may be extracted. The contour acquisition unit 121 according to the present exemplary embodiment obtains the coordinates of a contour line based on the input image from which the arm area is extracted with a differential filter applied thereto.

The position acquisition unit 122 obtains information indicating a position of the user with respect to the information processing apparatus 100, from the input image. In the present exemplary embodiment, the position acquisition unit 122 estimates the position of the user with respect to the information processing apparatus 100 based on a position of the portion where the edge of the input image intersects the arm area.

The reference point identification unit 123 identifies a position of a reference point in the extracted arm area, and stores the position information in the RAM 111. The identified reference point is used to generate dictionary data for identifying a posture of a hand and perform matching processing between the input image and the dictionary data.

The feature amount acquisition unit 124 obtains a feature amount of the hand part in the obtained arm area. In the present exemplary embodiment, the identified reference point is used to divide a hand area showing the hand into partial areas of rotationally symmetrical shape, and obtains a plurality of feature amounts from the respective partial areas. Processing of the feature amounts using the partial areas of rotationally symmetrical shape will be described in detail below.

The generation unit 125 generates dictionary data corresponding to each of a plurality of postures of a hand identified by the information processing apparatus 100, based on the obtained feature amounts of the hand area. In particular, the generation unit 125 generates a plurality of feature amounts obtained from the partial areas of rotationally symmetrical shape as a piece of dictionary data.

The posture identification unit 126 identifies the posture of the hand of the user when the input image is captured, based on matching processing between the feature amounts obtained from the input image and the feature amounts of dictionary data generated in advance. The posture identification unit 126 stores the identification result in the RAM 111. In the present exemplary embodiment, the posture identification unit 126 performs the matching processing on the plurality of feature amounts obtained from the partial areas of rotationally symmetrical shape by rotating a piece of dictionary data.

Other functional units may be constituted according to the intended use and applications of the information processing apparatus 100. Examples include a detection unit that detects position coordinates indicated by the user with a fingertip from the input image, a recognition unit of a gesture operation, and a display control unit that controls an image output to the projector 118.

Before a detailed description of processing of the information processing apparatus 100 according to the present exemplary embodiment, a method for identifying an orientation (direction) of an object having a predetermined shape will be described. The method is used for machine vision (MV) as discussed in Japanese Patent Application Laid-Open No. 10-63318. In the following example, on the assumption that object is placed on the operation surface 104, an amount of rotation of the object rotating within the xy plane is determined based on analysis of a range image obtained by the range image sensor 115.

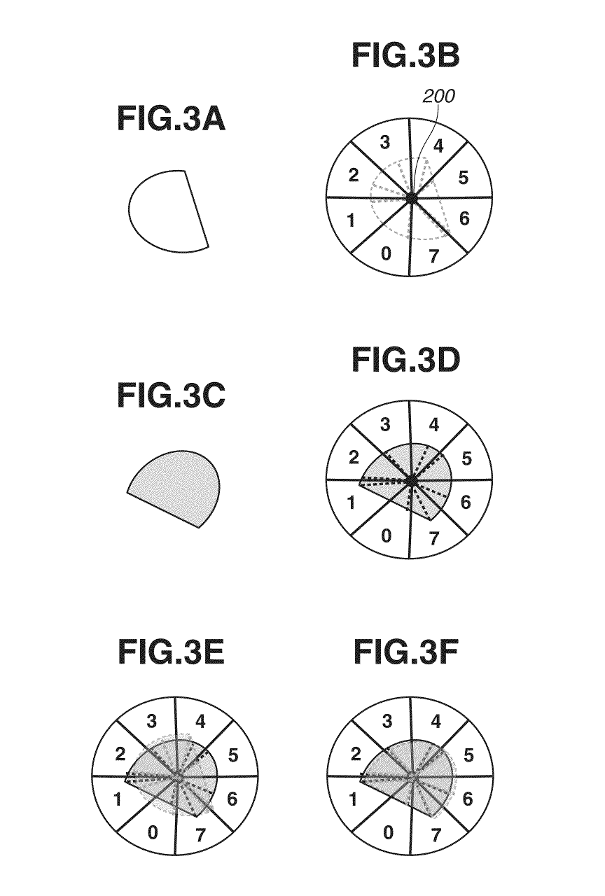

FIG. 3A illustrates the shape of an object to be recognized, which is extracted from the range image, in a contour line. FIG. 3B is a diagram schematically illustrating the contents of dictionary data generated for the object. The dictionary data here is feature amount data calculated from information about the shape extracted from the range image when the object to be recognized is placed on the operation surface 104 at a certain known angle.

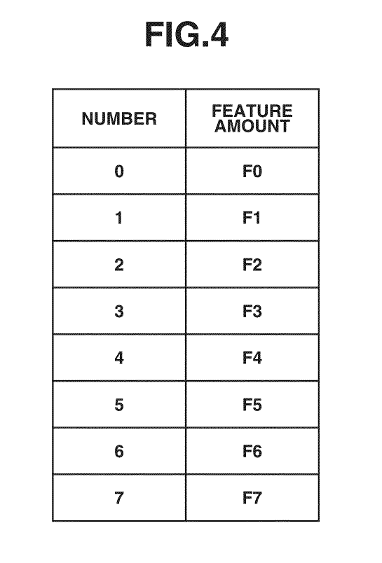

Feature amounts illustrated in FIG. 3B are calculated by the following processing. Initially, the position of a center of gravity 200 is determined as a reference point to be used for feature amount calculation processing based on the shape of the object. A virtual circular area that includes the object is set with the center of gravity 200 at the center. The set circle is divided into N equal sectors, whereby the object is divided into N rotationally symmetrical areas. N is a natural number of two or more. In the case of FIG. 3B, the circular area and eight sectors (N=8) obtained by dividing the circular area are illustrated in solid lines. In FIG. 3B, the sectors are each designated and identified by inside identification numbers of 0 to 7. For each sector, the distance between the xy coordinates of each point indicating the contour of the object included in the sector and the xy coordinates of the reference point 200 is determined. A maximum distance among the determined distances is assumed as the feature amount of the object in that sector. In FIG. 3B, the feature amounts obtained from the respective sectors are illustrated in broken lines that connect the reference point 200 and the contour of the object. A set of eight pieces of feature amount data obtained from the eight sectors constitute a piece of dictionary data. FIG. 4 illustrates an example of a format of data stored as dictionary data. The information stored as the dictionary data includes only the set of pieces of feature amount data, not information about the contour line.

Next, a method for identifying the orientation of the object based on matching processing between the foregoing dictionary data and a range image obtained as an input (hereinafter, referred to as input image) will be described. FIG. 3D illustrates a state where the contour of the same object as the one illustrated in FIG. 3A is extracted from an input image captured while the object is rotated. The matching processing is performed in the following procedure. As with the dictionary data, a center of gravity of the input image is initially determined as a reference point, and feature amounts are calculated.

Then, a degree of similarity (matching score) between the feature amounts of sectors 0 to 7 of the dictionary data and those of sectors 0 to 7 of the input image is calculated. For example, a reciprocal of the sum of squared errors is determined and stored as a matching score in a case where a rotation angle is 0 degree. Next, the dictionary data is rotated clockwise by 2π/N, i.e., as much as one sector. A matching score between the feature amounts of the sectors in corresponding positions is determined again. The value is stored as a matching score at a rotation angle of 2π/N. In such a manner, the processing for rotating the dictionary data by 2π/N and then determining a matching score is repeated N−1 times to obtain matching scores for one rotation of the dictionary data. If the object extracted from the input image is in the same orientation as when the dictionary data is generated, the matching score between the feature amounts of the object obtained from the input image and those of the dictionary data becomes maximum. For example, FIG. 3E illustrates a case where the matching processing is performed between the dictionary data (light-color portion) at a rotation angle of 0 and the input image illustrated in FIG. 3D. FIG. 3F illustrates a case where the matching processing is performed between the dictionary data rotated by 2π/8×3 and the input image. FIG. 3F illustrates the state where the highest matching score is obtained. By such processing, the rotation angle of the object is identified to be 2π/8×3. The above is the processing for identifying the orientation of one type of object having a known shape using a piece of dictionary data. A plurality of pieces of dictionary data corresponding to a respective types of objects may be stored in advance. This enables identification of a type of an object included in an input image and identification of the orientation of the object. Specifically, the processing for determining a matching score is performed on the shape of the target object included in the input image by rotating each of the pieces of dictionary data. As a result, the target object is identified as a type of object corresponding to the dictionary data with which the highest matching score is obtained. Determining the matching scores stepwise by rotating the dictionary data enables robust processing on a rotated object. If the matching scores calculated by rotating each of the pieces of dictionary data do not exceed a predetermined threshold, the object can be determined as an unknown object of which dictionary data is not prepared in advance.

The foregoing example is described on the assumption that the object, the orientation of which is to be identified, is smaller than the operation surface 104 in size and can be placed on the operation surface 104 by itself, like machine parts. Such an object is extracted as an area that exists in the input image in an isolated state without contact with the edges of the image. Hereinafter, such an object will thus be referred to as an isolated object. The isolation object means that every portion of the contour detectable by the range image sensor 115 contributes to the identification of the shape and orientation. To apply the method for identifying the shape and orientation of the isolated object, to the processing for identifying a posture of a human hand in the present exemplary embodiment, there are several issues that need to be addressed. The manners in which such issues are addressed will be described below in detail.

In the present exemplary embodiment, a posture of a hand refers to the shape of the hand part including four fingers, a thumb, a palm, and a back of the hand. The user can change the posture mainly by moving or bending the fingers and the thumb in different ways, or by moving the hand entirely. For example, postures can be identified by a difference in the number of bent fingers. In the following description, for example, a posture formed by sticking out only the forefinger and clenching the rest of the fingers and the thumb into the palm will be referred to as a “pointing posture.” A state of the hand where all the four fingers and the thumb are extended out will be referred as a “paper posture,” since the posture resembles to the hand posture in the scissors-paper-stone game (also known as “rock-paper-scissors” game). Therefore, a state where all the four fingers and the thumb are clenched into the palm will be referred to a “stone posture.”

### <Acquisition of Feature Amounts>

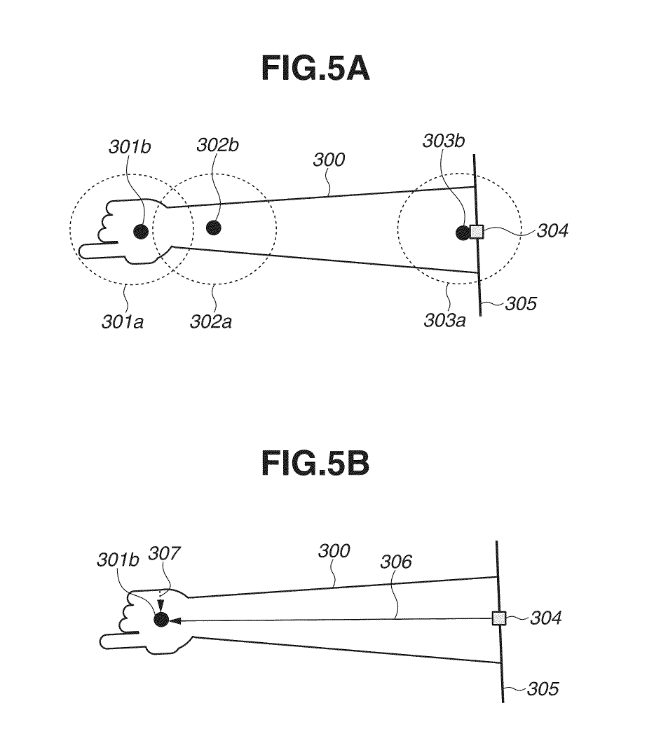

Processing for identifying a reference point of an arm area which is needed to perform processing for identifying the posture of a human hand based on a captured image of the human hand will be described with reference to FIG. 5. As described above, if orientation of an isolated object is to be identified, dictionary data can be generated with the center of gravity as a reference point. The matching processing can then be performed with the input image by rotating the dictionary data about the center of gravity. However, if the input image is a captured image of a human hand, the extracted arm area usually includes not only the hand (the tip part from the wrist) but the entire arm including such portions as the wrist and the elbow. For example, FIG. 5A illustrates an enlarged portion of the input image extracted as an arm area. In FIG. 5A, an arm 300 enters the image through an image edge 305. In the present exemplary embodiment, if an object intersecting the image edge 305 is detected, a coordinate position indicated by average coordinate values of pixels corresponding to the intersection is identified as the coordinates of the entry position. In FIG. 5A, the entry position corresponds to a point 304. The definition of the entry position is not limited thereto. For example, the entry position may be a representative point that satisfies a predetermined condition from among the coordinates where the object is in contact with an image edge. Alternatively, the entry position may be at average coordinates of the portion where the object and an edge of the operation surface 104 intersect. In the present exemplary embodiment, the entry position refers to position information indicating the position (standing position) of the user with respect to the information processing apparatus 100. The information processing apparatus 100 according to the present exemplary embodiment obtains the input image using the range image sensor 115 arranged to face the operation surface 104. The information processing apparatus 100 therefore uses the foregoing concept of the entry position to estimate the user's position estimated based on the arm in the input image and the image edge. If the standing position of the user with respect to the information processing apparatus 100 can be detected by a different device, the resulting position information may be converted into an image on the xy plane and used. For example, a camera or sensor installed on the ceiling may be used.

In the arm area, the wrist and the elbow may form various shapes, irrespective of the posture of the hand part. If the center of gravity of the arm area is defined as a reference point, the posture of the hand part cannot be determined by a matching method that is performed by rotating only one piece of dictionary data about the center of gravity. Preparing a plurality of patterns of dictionary data with the wrist and the elbow in different states is not practical because the amount of data to be stored can be enormous. For example, in FIG. 5A, a point 302b represents the center of gravity of the arm area in the input image with the wrist and the elbow extended. Since the portion from the wrist to the shoulder has a larger area than that of the hand part, the center of gravity is positioned far off the hand part. Consequently, even if a circular area 302a corresponding to the size of the hand part is set with the point 302b at the center, the hand part will not be included. In other words, to identify the posture of the hand using the method for performing matching with the input image by rotating the dictionary data around a reference point, an appropriate reference point to be used as the center of rotation needs to be set.

To determine a reference point different from the center of gravity, there is a conventional method for identifying a point at a minimum distance from contour pixels of the object from among pixels of interest in an area showing the object within the input image. Specifically, by targeting on an internal pixel within the image area, values that represent the distances from each contour pixel in the area (there are a plurality of contour pixels) to the targeted internal pixel are initially determined. And the minimum distance value among the values is specified. The value of the targeted internal pixel is replaced with the minimum distance value. Such replacement is performed on all the internal pixels, and then a point that maximizes the pixel value is searched for. In an intuitive sense, such a method is to search for the widest part of the object. The widest part of the arm area, however, may fall on the hand part or the arm part depending on the angle and distance between the range image sensor 115 and the arm. For example, a point 303b is a reference point obtained by the method if in the captured input image, the widest part of the arm falls on the shoulder-side edge. If a circular area 303a corresponding to the size of the hand is set with the point 303b at the center, the hand part will not be included. An appropriate reference point for the matching processing for identifying the posture of the hand is thus difficult to determine by simply searching for the widest part of the object.

In comparison to the conventional method described above, reference point identification processing according to the present exemplary embodiment will be described with reference to FIG. 5B. To identify the posture of a hand by the method for performing matching with the input image by rotating the dictionary data, it is most efficient to obtain a reference point like a point 301b and divide a circular area around the reference point to identify feature amounts. The point 301b is the center of the hand in the arm area. The part to be recognized as the hand in the arm area does not include the portion extending from the wrist to the shoulder side. That is, the hand lies relatively far from the entry position in the arm area. Meanwhile, the center of the hand can be said to be the center of the widest part in the tip portion from the wrist. In the present exemplary embodiment, the distance from the entry position and the minimum distance from the contour are thus obtained with respect to each pixel in the arm area. The position of a pixel that maximizes a score identified based on the distances is then identified as the position of the reference point for identifying the posture of the hand by the method for performing matching with an input image by rotating the dictionary data. In FIG. 5B, an arrow 306 indicates the Euclidean distance from the entry position 304 to the reference point 301b. A broken-lined arrow 307 indicates the minimum Manhattan distance between the contour and the reference point 301b.

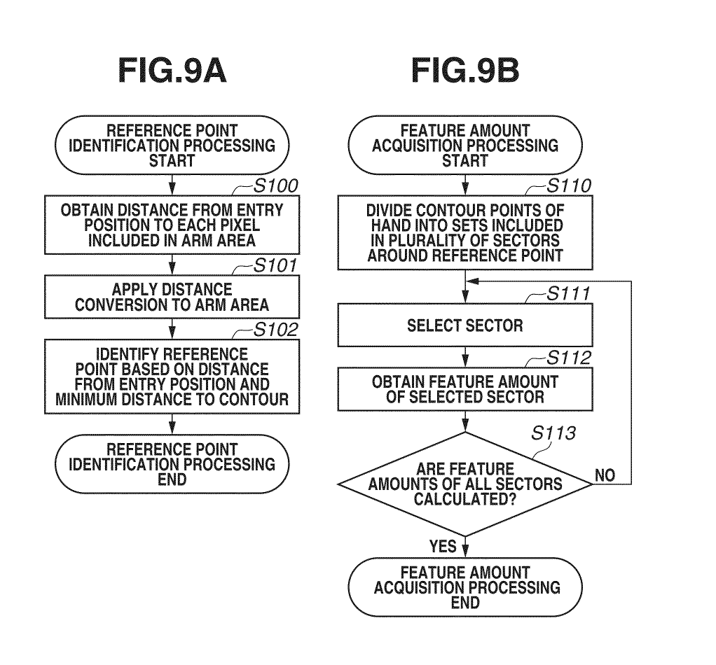

FIG. 9A is a flowchart illustrating a flow of the foregoing reference point identification processing. The reference point identification processing is performed before feature amount acquisition processing is performed during the processing for generating dictionary data for identifying the posture of a hand or the proceeding for identifying the posture of a hand.

In step S100, the feature amount acquisition unit 124 obtains a distance from the entry position to the position of each pixel included in the arm area stored in the RAM 111, and stores the distance in the RAM 111. In the present exemplary embodiment, Euclidean distances are used as the distances. Other distance scales may also be used. In step S101, the feature amount acquisition unit 124 applies distance conversion to the arm area stored in the RAM 111, and stores the resulting values in the RAM 111. In the present exemplary embodiment, Manhattan distances are used as the distances. Other distance scales may also be used. In step S102, the feature amount acquisition unit 124 calculates a score of each pixel by using the distance from the entry position at the position of each pixel stored in the RAM 111 and the distance-converted value of each pixel. For example, the score can be calculated by the following equation 1:

Score=the distance from the entry position×the minimum distance to the contour

Finally, the feature amount acquisition unit 124 selects a pixel that maximizes the score as the reference point of the hand, and stores the reference point in the RAM 111.

The above is the processing for identifying the reference point of the arm area to perform the matching processing with an input image by rotating the dictionary data during the processing for identifying the posture of the hand according to the present exemplary embodiment.

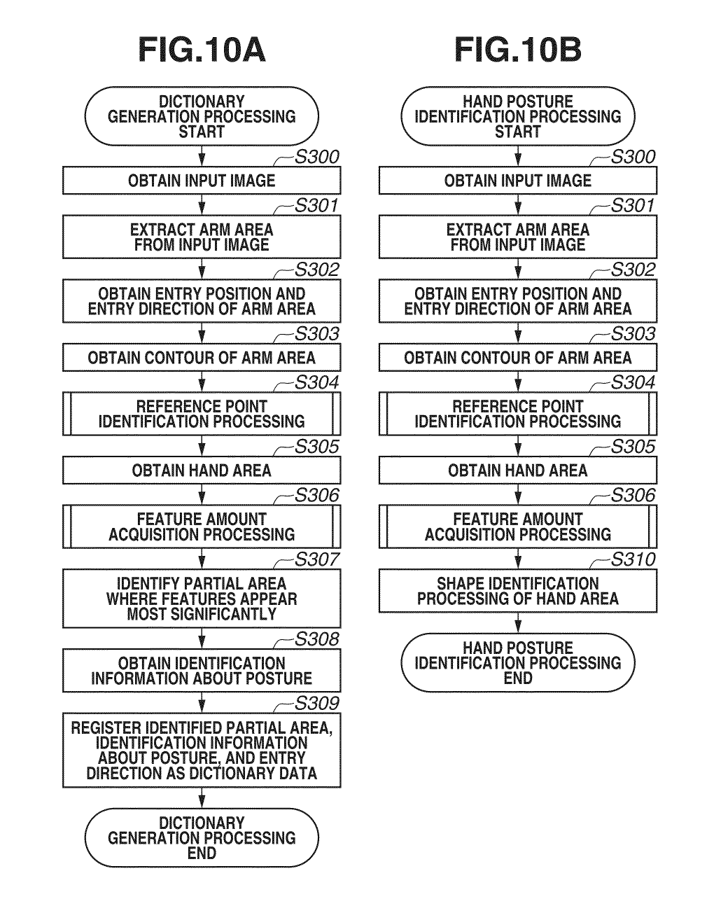

Next, processing for obtaining the feature amounts of the shape of the hand in an input image obtained by the range image sensor 115 based on the reference point will be described. The reference point is identified by the foregoing processing. FIG. 10B is a flowchart illustrating an example of a flow of the feature amount acquisition processing according to the present exemplary embodiment. This processing is performed after the reference point identification processing during the processing for generating dictionary data on the posture of the hand and the processing for identifying the posture of the hand.

In step S110, the feature amount acquisition unit 124 divides contour points of the hand stored in the RAM 111 into sets which are included in a plurality of sectors having a predetermined radius with the reference point at the center. The feature amount acquisition unit 124 stores the resultant in the RAM 111. In step S111, the feature amount acquisition unit 124 selects one of the sectors stored in the RAM 111. In step S112, the feature amount acquisition unit 124 obtains a feature amount of the sector selected in step S111. In the present exemplary embodiment, the feature amount acquisition unit 124 calculates the distances from the respective positions of the contour points included in the selected sector to the reference point, and stores the maximum value in the RAM 111 as the feature amount of the sector. In step S113, the feature amount acquisition unit 124 determines whether the feature amounts of all the sectors are calculated. If there is any unprocessed sector (NO in step S113), the processing returns to step S111. The processing is repeated until all the sectors are processed. If the feature amounts of all the sectors are calculated (YES in step S113), the feature amount acquisition processing ends.

As described above, in the present exemplary embodiment, an arm area is extracted from the image obtained by the range image sensor 115. A reference point for targeting the hand is determined in the arm area. A circular area set around the reference point is divided into a plurality of sectors, and feature amounts are obtained in units of the sectors. This enables the generation of efficient dictionary data that can be used regardless of the states of the wrist and the elbow, and the matching processing can be performed.

### <Generation of Dictionary>

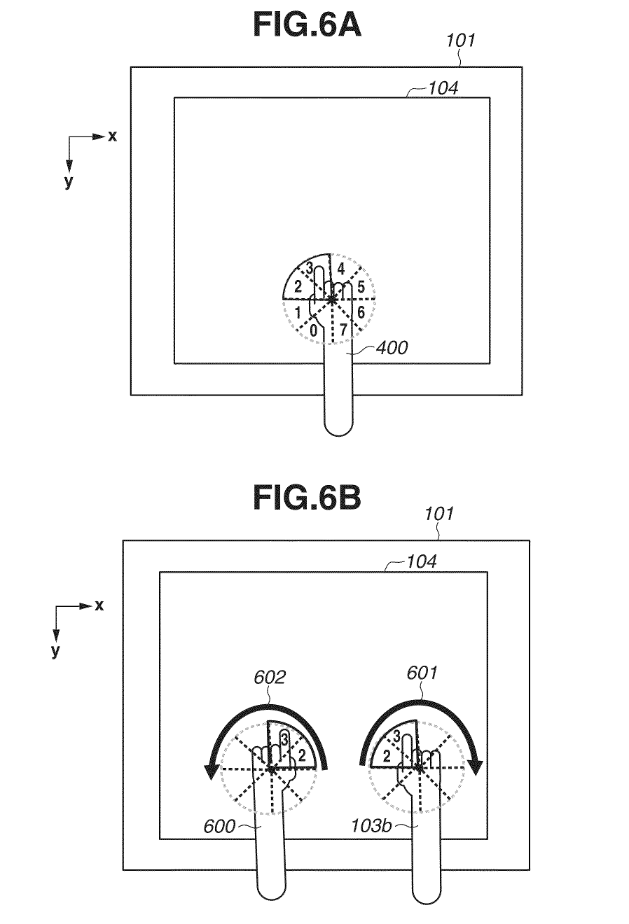

Next, the processing for generating dictionary data in advance for use in the processing for identifying the posture of a hand according to the present exemplary embodiment will be described in detail. If the object to be recognized is an isolated object, the entire contour has a meaning in identifying the orientation of the object. This is not always the case if the object to be recognized is the hand. For example, suppose that the arm area included in a circular area having a predetermined radius around the reference point 301b illustrated in FIG. 5B is obtained as the hand area of the user. In the present exemplary embodiment, feature amounts are obtained in units of sectors set around the reference point 301b by the foregoing processing. In the hand area, the shape of the wrist part remains unchanged regardless of what posture the user's hand takes. If the dictionary data includes the feature amounts of such a portion having no meaning in posture identification, a higher matching score can be more likely calculated even between actually different postures. In other words, misrecognition more likely occurs. In the present exemplary embodiment, only feature amounts corresponding to sectors where a feature of the posture of the hand appears, are selected as dictionary data from among the feature amounts obtained from the respective sectors. In other words, in the present exemplary embodiment, featureless portions irrelevant to the identification of the posture of the hand are not included in the dictionary data. As an example, a case of generating dictionary data for distinguishing the “pointing posture” with only the forefinger sticking out from the “stone posture”, and identifying the “pointing posture” will be described. The two postures are distinguishable only by a difference in the shape of the forefinger part. The shapes of the contours of the other parts substantially coincide with each other. In the present exemplary embodiment, as for the “pointing posture,” at least the feature amounts of portions corresponding to the forefinger part are registered as the dictionary data corresponding to the posture. FIG. 6A illustrates an input image which captures a hand 400 when the hand 400 is taking the “pointing posture.” In such a case, the features of the pointing posture appear in the portions of sectors 2 and 3. At least the feature amounts of such portions are registered as the dictionary data of the “pointing posture.” In such a manner, the minimum feature amounts needed to distinguish the “pointing posture” from the “stone posture” are prepared as dictionary data in advance.

Next, dictionary generation processing according to the present exemplary embodiment will be described in detail with reference to the flowchart of FIG. 10A. The flowchart of FIG. 10A illustrates processing to be performed at the time of initialization of the information processing apparatus 100 or at the time of designing.

In step S300, the image acquisition unit 120 obtains information about a distance information from the range image sensor 115 as an input image, and stores the input image in the RAM 111. In step S301, the contour acquisition unit 121 obtains an arm area based on the input image stored in the RAM 111. For example, the contour acquisition unit 121 extracts an area that is a group of pixels lying in a position higher than the height of the operation surface 104 and at least part of which is in contact with an image edge as the arm area. The contour acquisition unit 121 stores the extracted area in the RAM 111 in association with a label for identification.

In step S302, the feature amount acquisition unit 124 obtains the entry position and an entry direction of the arm area based on the arm area stored in the RAM 111, and stores the entry position and the entry direction in the RAM 111. In the present exemplary embodiment, the entry direction is defined as a direction from the entry position toward the tip part of the hand. The feature amount acquisition unit 124 identifies a farthest point from the entry position among the pixels included in the arm area, based on differences between the xy coordinates indicating the positions of the pixels included in the arm area and the xy coordinates of the entry position. The feature amount acquisition unit 124 then determines a direction from the entry position toward the fingertips along the coordinate axis showing a greater coordinate value as the entry direction. Note that the definition of the entry direction is not limited thereto.

In step S303, the contour acquisition unit 121 obtains the contour of the arm area based on the arm area stored in the RAM 111. For example, the contour acquisition unit 121 can obtain the contour of the arm area by applying a differential filter to the input image from which the arm area is extracted. The contour acquisition unit 121 stores the obtained contour in the RAM 111. The farthest point from the entry position among the pixels included in the arm area is usually included in the contour. The processing of step S302 and the processing of step S303 may thus be performed in reverse order, in which case the contour points are searched for to find a point for the entry direction to be based on.

In step S304, the feature amount acquisition unit 124 obtains a reference point to be used for the acquisition of feature amounts based on the contour and the entry position stored in the RAM 111, and stores the obtained reference point in the RAM 111. Specifically, the feature amount acquisition unit 124 performs the flowchart of FIG. 9A. In step S305, the feature amount acquisition unit 124 obtains a hand area based on the position of the contour and the position of the reference point stored in the RAM 111, and stores the obtained hand area in the RAM 111. For example, the feature amount acquisition unit 124 obtains the inside of the contour points falling within a radius threshold with the reference point at the center as the hand area. In step S306, the feature amount acquisition unit 124 obtains feature amounts based on the hand area and the reference point stored in the RAM 111, and stores the feature amounts in the RAM 111. Specifically, the feature amount acquisition unit 124 performs the flowchart of FIG. 9B.

In step S307, the feature amount acquisition unit 124 identifies a partial area where the features of the posture of the hand most significantly appear among the partial areas of sector shape into which the hand area is divided, based on the feature amounts of the hand stored in the RAM 111. In step S308, the feature amount acquisition unit 124 obtains identification information about the posture to be registered as dictionary data. For example, the feature amount acquisition unit 124 obtains a name and identification number of the posture that are input by the user or designer of the information processing apparatus 100 when starting the dictionary generation processing. In step S309, the feature amount acquisition unit 122 associates and stores the partial area identified in step S307, the identification information about the posture obtained in step S308, and the entry direction obtained in step S302 in the holding unit 127 as dictionary data. In the present exemplary embodiment, a piece of dictionary data is thus generated for each type of posture of a hand. The foregoing dictionary generation processing is repeated at least as many times as the number of postures to be distinguished and identified according to the use environment of the information processing apparatus 100. A plurality of pieces of dictionary data may be prepared for the same posture, if needed, in association with different orientations of the user or different installation conditions of the range image sensor 115. In the present exemplary embodiment, a plurality of pieces of dictionary data with different entry directions is generated for the same posture.

As described above, in the present exemplary embodiment, a hand image is divided into partial areas. For each of the postures to be identified, at least a feature amount of a partial area where a feature significantly appears is selected and stored as dictionary data. This can reduce the occurrence of misidentification in the posture identification processing due to the effect of the wrist part which is inevitably included in the hand image regardless of the posture of the hand.

### <Identification of Posture of Hand>

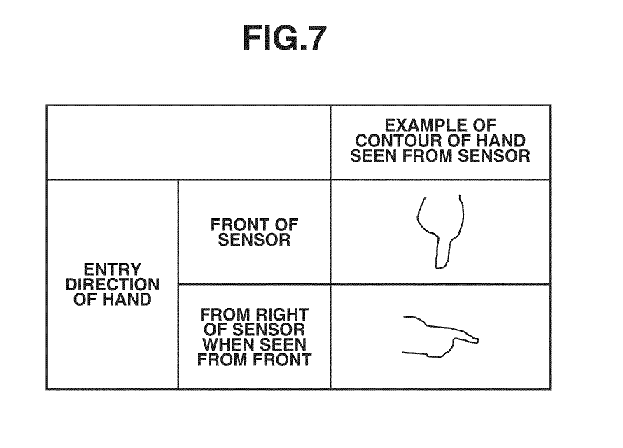

Next, the processing for identifying the posture of a hand according to the present exemplary embodiment will be described. In the present exemplary embodiment, as illustrated in FIG. 1, the light receiving unit 106 of the range image sensor 115 is installed to capture an image at a downward viewing angle toward the operation surface 104. The light receiving unit 106 may be installed at an oblique angle. As a result, even with the user's hand in the same posture, an input image can be different if the user's orientation such as the entry direction and entry position of the hand changes. More specifically, the contour of the hand area can have different shapes, from which different feature amounts are obtained. For example, FIG. 7 illustrates a difference between the contours obtained from input images when the hand of an arm entering from a front direction of the range image sensor 115 takes the “pointing posture” and when the hand of an arm entering from the right of the range image sensor 115 takes the “pointing posture.” In the present exemplary embodiment, to enable the identification of the posture of a hand regardless of the user's orientation, a plurality of pieces of dictionary data with different entry directions are generated in advance for each of a plurality of postures. However, if the entire dictionary data generated in advance is used to identify a posture, the accuracy of the identification processing may rather drop due to the following reason. That is, features on a range image in a first entry direction where the hand takes a first posture can sometimes be similar to those on a range image in a second entry direction where the hand takes a second posture. In such a case, identification performance of the postures themselves drops. In the hand posture identification processing according to the present exemplary embodiment, dictionary data to be used for matching based on the entry direction of the user's arm is selected.

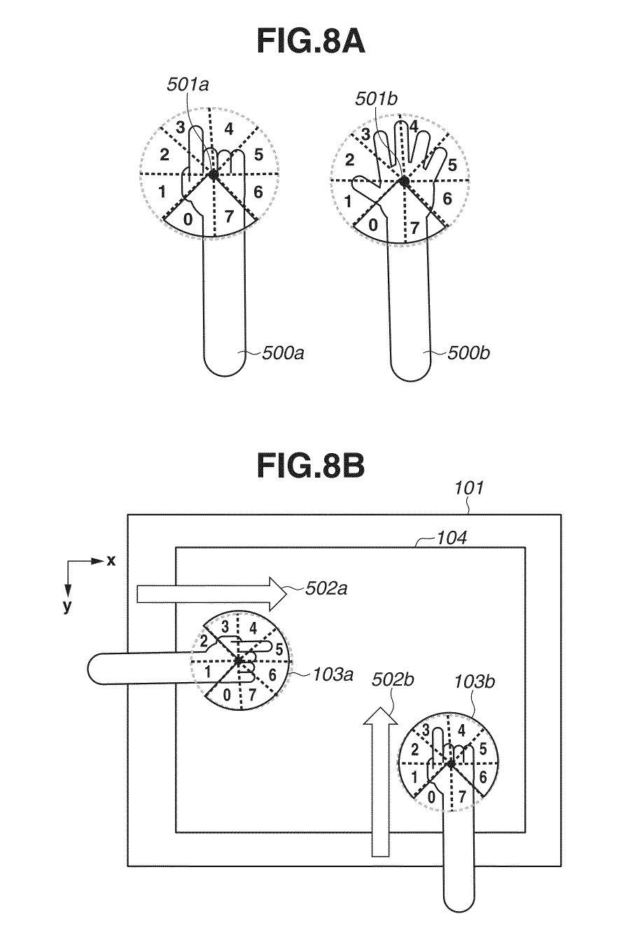

In the present exemplary embodiment, in the dictionary generation processing, the features of partial areas meaningless to the identification of the posture of a hand are excluded from the dictionary data. Similarly, the processing for identifying a posture includes additional control to previously identify portions irrelevant to the identification of a posture and not perform matching between such portions and the dictionary data. This will be described in detail with reference to FIGS. 8A and 8B. In FIG. 8A, an arm 500a schematically illustrates a case when the hand takes the “pointing posture,” and an arm 500b a case where the hand takes the “paper posture.” Points 501a and 501b represent respective reference points identified by the reference point identification processing. Despite the different postures of the hands, the arms 500a and 500b have almost the same shapes and feature amounts in the portions of sectors 0 and 7, i.e., in the contour of the wrist part. Like the limitation of the partial areas to be used for the dictionary data, in the present exemplary embodiment, portions irrelevant to the identification of a posture are excluded from the matching processing performed by rotating the dictionary data. Specifically, portions that are likely to be a wrist part in the hand area are identified based on the entry direction. FIG. 8B illustrates the operation surface 104 as seen from above, which corresponds to a range image obtained by the range image sensor 115. The projection image of the projector 108 and display items are omitted. Arrows 502a and 502b indicate the entry directions of arms 103a and 103b. The borders of the sectors corresponding to units of feature amounts are illustrated in broken lines. Of the sectors, ones to be used for matching are surrounded by solid lines. Sectors corresponding to the wrist parts are excluded from the figure. In the case of the arm 103a, the entry direction is the positive direction of the x-axis as indicated by the arrow 502a. Sectors 1 and 2 lying in the negative direction of the x-axis can thus be estimated to be the sectors including the wrist part. Consequently, sectors 3, 4, 5, 6, 7, and 0 are used for the matching processing performed by rotating the dictionary data. In the case of the arm 103b, the entry direction is the negative direction of the y-axis as indicated by the arrow 502b. Sectors 0 and 7 lying in the positive direction of the y-axis can thus be estimated to be the sectors including the wrist part. Consequently, sectors 1, 2, 3, 4, 5, and 6 are used for the matching processing.

FIG. 10B is a flowchart illustrating a flow of the hand posture identification processing performed in the present exemplary embodiment. The series of processing from step S300 to step S306 is similar to the processing of the same step numbers in FIG. 10A. A detailed description thereof is thus omitted. However, while the posture of the hand of the user (or designer) in the input image obtained by the dictionary generation processing is known to the information processing apparatus 100 in advance, the posture of the hand of the user in the input image obtained by the hand posture identification processing is unknown. In the hand posture identification processing, the feature amounts are extracted in step S306, and then the processing proceeds to step S310. In step S310, the posture identification unit 126 performs processing for identifying the posture from the shape of the hand part in the input image by matching the input image with dictionary data.

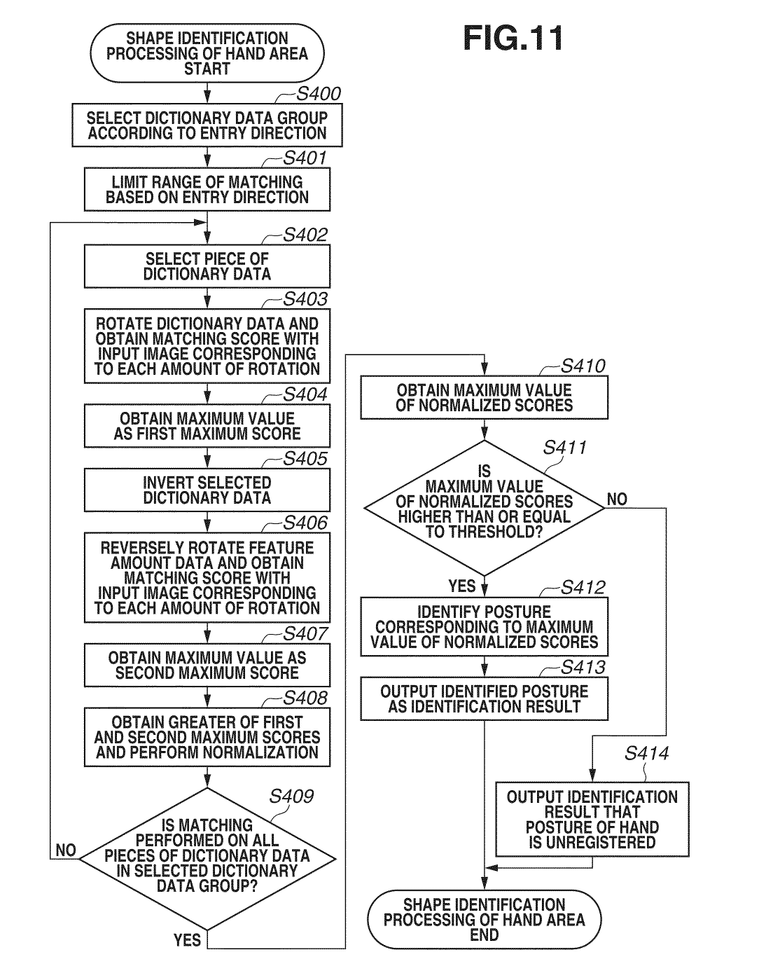

FIG. 11 is a flowchart illustrating details of step S310. In step S400, the posture identification unit 126 selects a dictionary data group according to the entry direction. Specifically, the posture identification unit 126 reads dictionary data from the storage unit 127, and obtains information about the entry direction of the hand obtained in step S102 from among the pieces of information stored in the RAM 111. The posture identification unit 126 then selects a stored dictionary data group in association with the obtained entry direction from the dictionary data. Details will be described below. In step S401, the posture identification unit 126 limits the range of matching within the hand area based on the entry direction of the hand stored in the RAM 111. Details will be described below. In step S402, the posture identification unit 126 selects a piece of dictionary data from the dictionary data group that is selected in step S400 and stored in the RAM 111. In step S403, the posture identification unit 126 performs matching with the input image by rotating the dictionary data selected in step S402 to obtain a matching score corresponding to each amount of rotation. In step S404, the posture identification unit 126 obtains the maximum value among the matching scores obtained in step S403 as a first maximum score.

In step S405, the posture identification unit 126 obtains feature amount data by inverting the dictionary data selected in step S402. The processing for inverting the dictionary data will be described below. In step S406, the posture identification unit 126 performs matching with the input image by reversely rotating the feature amount data obtained by the inversion in step S405 to obtain a matching score corresponding to each amount of rotation. In step S407, the posture identification unit 126 obtains the maximum value among the matching scores obtained in step S406 as a second maximum score.

In step S408, the posture identification unit 126 selects the greater of the first and second maximum scores obtained in steps S404 and S407. The posture identification unit 126 then performs normalization according to a normalization constant corresponding to the dictionary data, and stores the normalized score in RAM 111. In step S409, the posture identification unit 126 determines whether matching is performed on all the dictionary data selected in step S400. If it is determined that there is unprocessed dictionary data (NO in step S409), the processing returns to step S402. The processing of steps S402 to S409 is repeated until all the dictionary data is processed. On the other hand, if all the dictionary data is determined to have been processed (YES in step S409), the processing proceeds to S410.

In step S410, the posture identification unit 126 obtains the maximum value of the normalized scores obtained in step S408 and the corresponding dictionary data. In step S411, the posture identification unit 126 determines whether the maximum value of the normalized scores obtained in step S410 is equal to or higher than a predetermined threshold. If the maximum value of the normalized scores is determined to be equal to or higher than the threshold (YES in step S411), the processing proceeds to step S412. On the other hand, if the maximum value of the normalized scores is determined to not be equal to or higher than the threshold (NO in step S411), the processing proceeds to step S414.

In step S412, the posture identification unit 126 identifies the posture corresponding to the maximum value of the normalized scores from the obtained dictionary data, and stores the information in the RAM 111 as information about an identification result. In step S413, the posture identification unit 126 outputs the identification result to a display control unit and/or a control unit that controls the functions of an application. In step S414, the posture identification unit 126 outputs an identification result that the posture of the hand is an unregistered one, to the display control unit and/or the control unit that controls the functions of the application. According to settings, the posture identification unit 126 stores the identification result in the RAM 111 if needed.

As illustrated in FIG. 8, in the present exemplary embodiment, the identification numbers to be assigned to the sectors are incremented clockwise, starting at the position of six o'clock regardless of the entry direction of the arm. Based on the assignment, the sectors are limited for the matching processing. Instead, the identification numbers of the sectors may be assigned according to the entry direction of the hand so that sectors of certain identification numbers are constantly excluded from the matching processing. For example, the identification numbers may be assigned to increment clockwise starting at a portion near the entry position of the arm. In such a case, sectors 0 and 7 can be constantly regarded as sectors including the wrist part, and can thus be excluded from the matching processing. In the present exemplary embodiment, the feature amount acquisition unit 124 performs the limitation of the identification numbers for matching after the feature amounts of all the sectors are determined. Instead, the feature amount acquisition unit 124 may limit the sectors which obtains the feature amounts according to the entry direction.

Now, the processing for inverting the dictionary data in step S405 to further repeat the matching processing will be described in detail.

The posture of a hand can often be symmetrical between when the user uses the right hand and when the user uses the left hand. If dictionary data is generated on both the left and right hands for every entry direction and every posture, the load of the dictionary generation and the data amount of the dictionary data become enormous. Therefore, in the present exemplary embodiment, dictionary data obtained based on an image of either the left or right hand is laterally-inverted and rotated around a reference point common to both the left and right hands to perform matching processing. Consequently, the posture can be accurately identified regardless of whether the left or right hand is used.

For example, FIG. 6B schematically illustrates processing for performing matching of not only a hand 103b (right hand) but also a left hand 600 by using dictionary data generated when the hand 103b takes the “pointing posture.” In the present exemplary embodiment, the feature amounts of the sectors corresponding to the forefinger part are stored as the dictionary data on the “pointing posture.” For the hand 103b, the dictionary data includes the feature amounts of sectors 2 and 3. In FIG. 6B, the inverted sectors are designated by the same identification numbers. In the present exemplary embodiment, in steps S402 to S404 of FIG. 11, the posture identification unit 126 performs the matching processing by rotating the feature amounts of sectors 2 and 3 clockwise as illustrated by an arrow 601 on the assumption that the user's hand is the right hand. In step S405, the posture identification unit 126 inverts the dictionary data. In steps S406 to S408, the posture identification unit 126 performs the matching processing by rotating the feature amounts of sectors 2 and 3 counterclockwise as illustrated by an arrow 602, in consideration of possibility that the user may use the left hand. The posture identification unit 126 then identifies the posture based on the dictionary data when the highest matching score is obtained in the series of processing. The posture can thus be identified even if either of the left and right hands is used to make a gesture operation.

As described above, according to the present exemplary embodiment, a hand image extracted from an input image is divided into partial areas, which are then limited to carry out the matching with dictionary data. In such a manner, the result of the identification processing can be quickly obtained without unnecessary processing load.

### <Use Example by Application>

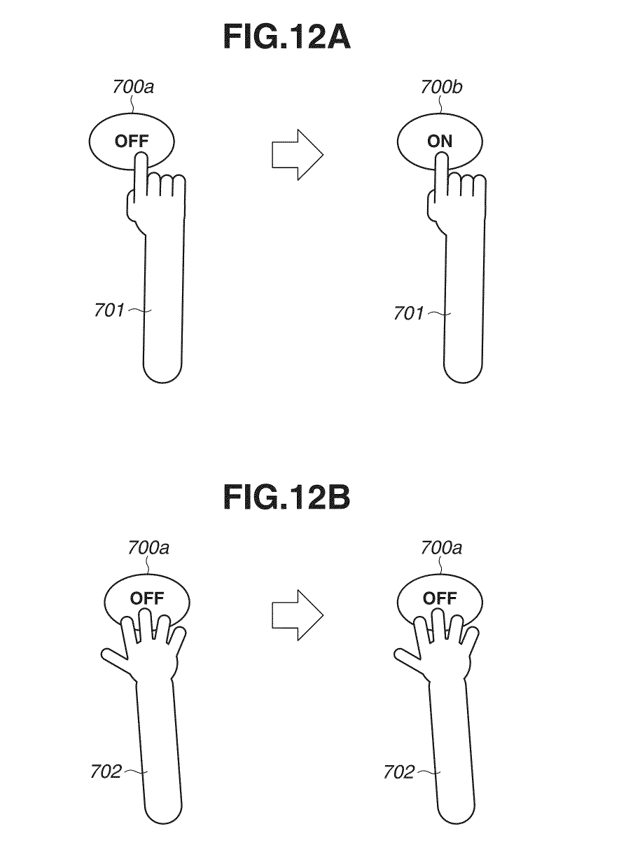

With the foregoing processing, various applications that use the identification of the posture of a hand can be designed in the information processing apparatus 100. For example, FIGS. 12A and 12B illustrate a case where an application switches between to enable and to not enable a touch operation on a display item depending on whether the posture of the hand is the “pointing posture.” In FIG. 12A, a user's hand 701 is taking the “pointing posture.” The application then keeps track of the fingertip position of the forefinger, and determines whether a display item 700a is touched. If the display item 700a is touched, the application issues a command associated with the display item 700a, and replaces the display item 700a with a display item 700b to feed back the identification of the touch operation. In FIG. 12B, a user's hand 702 is not taking the “pointing posture.” The application therefore does not issue a command or switch display even if the forefinger of the user touches the display item 700a. The identification of the posture of a hand can thus be used to make a response to a touch operation as intended by the user and make easy-to-understand feedback.

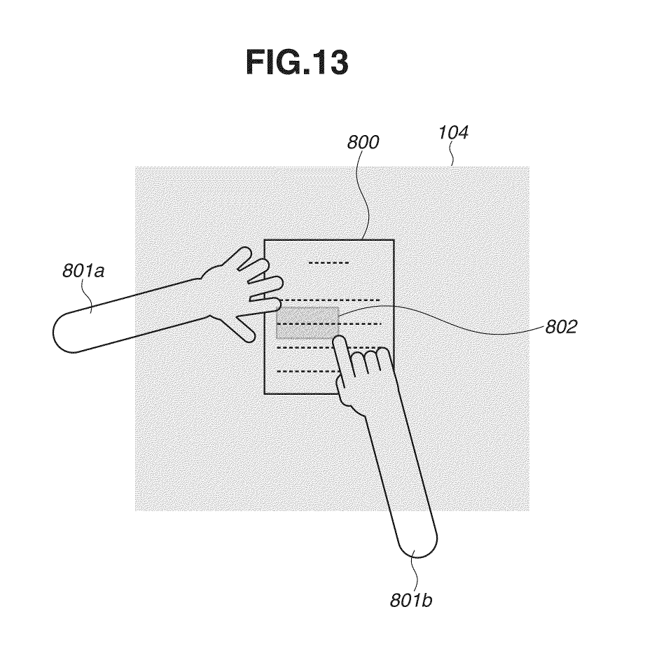

FIG. 13 illustrates a state where the user operates a document 800 on the operation surface 104 by using both right and left hands. The document 800 is a paper object on which character strings are printed. The following description deals with a case where, if the forefinger of a right hand 801b taking the “pointing posture” moves over the document 800, an application performs a function of selecting a rectangular range 802 within the document 800 based on the position of the forefinger. To facilitate the selection operation of the forefinger, the user may hold the document 800 by a left hand 801a. According to the present exemplary embodiment, the application can identify and keep track of the postures of the hands 801a and 801b to distinguish the hand 801b of the “pointing posture” which inputs the selection operation from the hand 801a which simply holds the document from moving. Consequently, the user can use the application by more natural operations with a higher degree of freedom.

In the foregoing exemplary embodiment, a single information processing apparatus 100 is configured to perform both the generation of the dictionary data and the identification of the posture of a hand. However, apparatuses specialized in respective functions may be provided. For example, a dictionary generation apparatus may be configured to generate dictionary data. An identification apparatus may be configured to obtain the generated dictionary data via an external storage device such as a server or a storage medium, and use the dictionary data for matching processing with an input image.

According to an exemplary embodiment of the present invention, it is possible to improve the efficiency of processing for identifying the postures of human hands stretched in a plurality of directions based on matching of an input image and dictionary data.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-199182, filed Sep. 29, 2014, which is hereby incorporated by reference herein in its entirety.

What is claimed is:

1. An apparatus comprising:
an extraction unit configured to extract an area showing an arm of a user from a captured image of a space into which the user inserts the arm;
a reference point determination unit configured to determine a reference point within a portion corresponding to a hand in the area extracted by the extraction unit;
a feature amount acquisition unit configured to obtain a feature amount of the hand corresponding to an angle around the reference point determined by the reference point determination unit; and
an identification unit configured to identify a shape of the hand of the user in the image by using a result of comparison between the feature amount obtained by the feature amount acquisition unit and a feature amount obtained from dictionary data indicating a state of the hand of the user, the feature amount obtained from the dictionary data corresponding to an angle around a predetermined reference point.

2. The apparatus according to claim 1, wherein the identification unit is configured to identify the shape of the hand of the user in the image based on a degree of similarity calculated each time the feature amount obtained by the feature amount acquisition unit and the feature amount obtained as the dictionary data are rotated around their respective reference points by a predetermined angle.

3. The apparatus according to claim 1, further comprising an image acquisition unit configured to obtain an image, an image being captured by an imaging unit arranged in a position to look down at the space from above,
wherein a head of the user is not included in a view angle of the imaging unit.

4. The apparatus according to claim 1, wherein the reference point determination unit determines the reference point based on a distance from a contour of the area to each point in the area and a distance from an intersection of the area and an end of the image, to each point in the area.

5. The apparatus according to claim 1, wherein the identification unit regards a portion where the area extracted by the extraction unit overlaps a circle of a predetermined size around the reference point identified by the reference point identification unit as the hand extended from a wrist.

6. A method for controlling an apparatus, comprising:
extracting an area showing an arm of a user from a captured image of a space into which the user inserts the arm;
determining a reference point within a portion corresponding to a hand in the area extracted by the extracting;
obtaining a feature amount of the hand corresponding to an angle around the reference point determined by the determining a reference point; and
identifying a shape of the hand of the user in the image by using a result of comparison between the feature amount acquired by the obtaining a feature amount and a feature amount obtained from dictionary data indicating a state of the hand of the user, the feature amount obtained from the dictionary data corresponding to an angle around a predetermined reference point.

7. A storage medium storing a program for causing a computer to perform a method for controlling an apparatus, the method comprising:
extracting an area showing an arm of a user from a captured image of a space into which the user inserts the arm;
determining a reference point within a portion corresponding to a hand in the area extracted by the extracting;
obtaining a feature amount of the hand corresponding to an angle around the reference point determined by the determining a reference point; and
identifying a shape of the hand of the user in the image by using a result of comparison between the feature amount acquired by the obtaining a feature amount and a feature amount obtained from dictionary data indicating a state of the hand of the user, the feature amount obtained from the dictionary data corresponding to an angle around a predetermined reference point.

8. An apparatus comprising:
an image acquisition unit configured to obtain a captured image of a space into which a user is able to insert an arm;
a contour acquisition unit configured to obtain information indicating a position of a contour of an area showing the arm of the user in the image obtained by the image acquisition unit;
a position acquisition unit configured to obtain information indicating a position of the user with respect to the apparatus;
a reference point identification unit configured to identify a reference point of an area corresponding to a hand part of the arm of the user within the area showing the arm of the user based on the information indicating the position of the contour obtained by the contour acquisition unit and the information indicating the position of the user obtained by the position acquisition unit;
a partial area acquisition unit configured to divide a circular area having a predetermined radius around the reference point identified by the reference point identification unit, into N (N is a natural number of two or more) equal sectors, thereby dividing a portion where the area showing the arm of the user overlaps the circular area, into partial areas; and
a feature amount acquisition unit configured to obtain a feature amount in each of the partial areas by using the information indicating the position of the contour obtained by the contour acquisition unit.

9. The apparatus according to claim 8, wherein the image obtained by the image acquisition unit is captured by an imaging unit arranged in a position to look down at the space from above, and
wherein a head of the user is not included in a viewing angle of the imaging unit.

10. The apparatus according to claim 8, wherein the position acquisition unit obtains a position indicating a portion of the image obtained by the image acquisition unit, where the area showing the arm of the user intersects an end of the image, as the information indicating the position of the user.

11. The apparatus according to claim 8, further comprising a generation unit configured to generate dictionary data corresponding to a posture of the hand when the image is obtained by the image acquisition unit, based on the feature amount obtained by the feature amount acquisition unit.

12. The apparatus according to claim 11, wherein the generation unit stores at least a feature amount obtained from a partial area where a feature of the posture of the hand, when the image is obtained by the image acquisition unit, most significantly appears, among a plurality of feature amounts obtained from a plurality of partial areas divided into the sectors, as the dictionary data corresponding to the posture of the hand.

13. The apparatus according to claim 8, further comprising a generation unit configured to generate dictionary data corresponding to a posture of the hand when the image is obtained by the image acquisition unit based on the feature amount obtained by the feature amount acquisition unit,
wherein the generation unit obtains identification information about the posture of the hand when the image is obtained by the image acquisition unit, and
wherein N feature amounts obtained from the respective N sectors are stored as the dictionary data corresponding to the posture of the hand when the image is obtained by the image acquisition unit.

14. The apparatus according to claim 8, further comprising a posture identification unit configured to identify a posture of the hand when the image is obtained by the image acquisition unit based on the feature amount obtained by the feature amount acquisition unit.

15. The apparatus according to claim 14, wherein the posture identification unit identifies the posture of the hand when the image is obtained, based on a degree of similarity between a feature amount included in dictionary data corresponding to a predetermined posture of a hand and the feature amount obtained by the feature amount acquisition unit.

16. The apparatus according to claim 15, wherein the posture identification unit identifies the posture of the hand when the image is obtained, based on the degree of similarity between the feature amount included in the dictionary data corresponding to the predetermined posture of a hand when rotated by predetermined angles and the feature amount obtained by the feature amount acquisition unit.

17. The apparatus according to claim 14, wherein the posture identification unit selects dictionary data to be used to identify the posture of the hand when the image is obtained from dictionary data stored in advance based on a direction from the position of the user indicated by the information obtained by the position acquisition unit toward a fingertip of the arm of the user.

18. The apparatus according to claim 11, wherein the generation unit stores the direction from the position of the user indicated by the information obtained by the position acquisition unit toward the fingertip of the arm of the user, in association with the feature amount obtained by the feature amount acquisition unit.

19. The apparatus according to claim 8, wherein the reference point identification unit identifies a point, where a minimum distance from the position of the contour indicated by the information obtained by the contour acquisition unit becomes greater and a distance from the position of the user indicated by the information obtained by the position acquisition unit becomes greater, as the reference point of the area corresponding to the hand part of the arm of the user in the area showing the arm of the user.

20. A method for controlling an apparatus, comprising:
obtaining a captured image of a space into which a user is able to insert an arm;
obtaining information indicating a position of a contour of an area showing the arm of the user in the image acquired by the obtaining an image;
obtaining information indicating a position of the user with respect to the apparatus;
identifying a reference point of an area corresponding to a hand part of the arm of the user within the area showing the arm of the user based on the information indicating the position of the contour acquired by the obtaining information indicating the position of the contour and the information indicating the position of the user acquired by the obtaining information indicating a position of the user;
dividing a circular area having a predetermined radius around the reference point identified by the identifying a reference point, into N (N is a natural number of two or more) equal sectors, thereby dividing a portion where the area showing the arm of the user overlaps the circular area, into partial areas; and
obtaining a feature amount in each of the partial areas by using the information indicating the position of the contour acquired by the obtaining information indicating the position of the contour.

21. A storage medium storing a program for causing a computer to perform a method for controlling an apparatus, the method comprising:
obtaining a captured image of a space into which a user is able to insert an arm;
obtaining information indicating a position of a contour of an area showing the arm of the user in the image acquired by the obtaining an image;
obtaining information indicating a position of the user with respect to the apparatus;
identifying a reference point of an area corresponding to a hand part of the arm of the user within the area showing the arm of the user based on the information indicating the position of the contour acquired by the obtaining information indicating the position of the contour and the information indicating the position of the user acquired by the obtaining information indicating a position of the user;
dividing a circular area having a predetermined radius around the reference point identified by the identifying a reference point, into N (N is a natural number of two or more) equal sectors, thereby dividing a portion where the area showing the arm of the user overlaps the circular area into partial areas; and
obtaining a feature amount in each of the partial areas by using the information indicating the position of the contour acquired by the obtaining information indicating the position of the contour.
